(19) United States
(12) Patent Application Publication
(10) Pub. No.: US 2024/0400876 A1
(43) Pub. Date: Dec. 5, 2024

(54) COOLANT AND HEAT PUMP REFRIGERANT

(71) Applicant: SHARP KABUSHIKI KAISHA, Osaka (JP)

(72) Inventors: NOBUKI SAKIKAWA, Osaka (JP); Hikari YAI, Osaka (JP)

(21) Appl. No.: 18/667,168

(22) Filed: May 17, 2024

(30) Foreign Application Priority Data
May 31, 2023 (JP) 2023-089750

(51) Int. Cl. C09K 5/04

(52) U.S. Cl. CPC C09K 5/047

(57) ABSTRACT

A coolant includes a temperature sensitive gel including a temperature sensitive polymer having hydrophilicity at a temperature lower than a lower critical solution temperature and hydrophobicity at a temperature higher than the lower critical solution temperature, and a polar solvent that wets the temperature sensitive polymer, the temperature sensitive gel undergoing a volume phase transition accompanied by an endothermic reaction in a case where a temperature rise exceeding the lower critical solution temperature occurs.

### BACKGROUND OF THE INVENTION

### 1. Technical Field

The present disclosure relates to a coolant and a heat pump refrigerant. This application claims the priority based on Patent Application No. 2023-089750 filed in Japan on May 31, 2023, the contents of which are hereby incorporated herein.

### 2. Description of the Related Art

The cooling system of an electronic device is roughly classified into an air cooling system, a water cooling system, and a phase change cooling system.

In cooling the electronic device by the air cooling system, an air flow is generated by a fan. Furthermore, heat is transferred from a heat source in the electronic device to air flowing by the airflow. As a result, heat is removed from the heat source, and the heat source is cooled.

In cooling the electronic device by a liquid cooling system, a circulating liquid flow is generated by a pump. Furthermore, heat is transferred from the heat source in the electronic device to a liquid flowed by the liquid flow. As a result, heat is removed from the heat source, and the heat source is cooled.

In cooling the electronic device by the phase change cooling system, heat is transferred from the heat source in the electronic device to a liquid, and the liquid is changed into a gas. As a result, latent heat necessary for the liquid to be changed into the gas is removed from the heat source, and the heat source is cooled. The gas changed from the liquid is cooled at a position away from the heat source to change into the liquid. The liquid changed from the gas returns around the heat source. The cooling of the electronic device by the phase change cooling system has attracted attention as a pump-less technique that does not require a pump.

JP 2019-140247 A discloses a cooling device. In the cooling device, a refrigerant liquid evaporates by taking heat generated by a heat generating element immersed in the refrigerant liquid as latent heat, becomes refrigerant vapor, and holds heat in the form of heat of vaporization. The refrigerant vapor releases vaporization heat to the outside through a housing wall or through the housing wall and a heat dissipation member. The refrigerant vapor that has released the heat of vaporization condenses and becomes a refrigerant liquid again. The condensed refrigerant liquid propagates along the housing wall or directly falls and returns to the pooled refrigerant liquid. As a result, the refrigerant can cool the heat generating element by phase change (paragraphs 0012, 0015, and 0024).

### SUMMARY

The cooling of the electronic device by the air cooling system requires additional equipment such as a fan. The cooling of the electronic device by the liquid cooling system requires additional equipment such as a pump. The cooling of the electronic device by the phase change cooling system requires a space for changing a gas into a liquid at a position away from the heat source and returning the liquid changed from the gas to the periphery of the heat source. For example, the cooling device disclosed in JP 2019-140247 A requires a space for condensing refrigerant vapor above the heat generating element to change the refrigerant vapor into a refrigerant liquid, and dropping the refrigerant liquid changed from the refrigerant vapor to return the refrigerant liquid to the periphery of the heat generating element.

Therefore, in the cooling of the electronic device by the air cooling system, the water cooling system, and the phase change cooling system, an element for cooling occupies a large space. This problem also occurs in cooling of devices other than the electronic device.

One aspect of the present disclosure has been made in view of this problem. An object of one aspect of the present disclosure is to provide a coolant and a heat pump refrigerant that can efficiently cool a device without occupying a large space.

A coolant according to a first aspect of the present disclosure includes a temperature sensitive gel including a temperature sensitive polymer having hydrophilicity at a temperature lower than a lower critical solution temperature and hydrophobicity at a temperature higher than the lower critical solution temperature, and a polar solvent that wets the temperature sensitive polymer, the temperature sensitive gel undergoing a volume phase transition accompanied by an endothermic reaction in a case where a temperature rise exceeding the lower critical solution temperature occurs.

A heat pump refrigerant according to a second aspect of the present disclosure includes the coolant according to the first aspect of the present disclosure and a liquid refrigerant mixed with the coolant.

### BRIEF DESCRIPTION OF THE DRAWINGS

FIG. 1 is a diagram schematically illustrating a microstructure of a coolant of a first embodiment at a temperature lower than a lower critical solution temperature (LCST);

FIG. 2 is a diagram schematically illustrating a microstructure of the coolant of the first embodiment at a temperature higher than the lower critical solution temperature;

FIG. 3 is a perspective view schematically illustrating an example of a shape of the coolant according to the first embodiment;

FIG. 4 is a perspective view schematically illustrating an example of a shape of the coolant according to the first embodiment;

FIG. 5 is a perspective view schematically illustrating an example of a shape of the coolant according to the first embodiment;

FIG. 6 is a perspective view schematically illustrating an example of a shape of the coolant according to the first embodiment;

FIG. 7 is a perspective view schematically illustrating an example of a shape of the coolant according to the first embodiment;

FIG. 8 is a perspective view schematically illustrating an example of a shape of the coolant according to the first embodiment;

FIG. 9 is a perspective view schematically illustrating an example of a shape of the coolant according to the first embodiment;

FIG. 10 is a perspective view schematically illustrating an example of a shape of the coolant according to the first embodiment;

FIG. 11 is a perspective view schematically illustrating an example of a shape of the coolant according to the first embodiment;

FIG. 12 is a perspective view schematically illustrating an example of a shape of the coolant according to the first embodiment;

FIG. 13 is a perspective view schematically illustrating an example of a shape of the coolant according to the first embodiment;

FIG. 14 is a plan view schematically illustrating an example of a shape of the coolant according to the first embodiment;

FIG. 15 is a plan view schematically illustrating an example of a shape of the coolant according to the first embodiment;

FIG. 16 is a perspective view schematically illustrating the coolant of the first embodiment and a circuit board cooled by the coolant;

FIG. 17 is a perspective view schematically illustrating the coolant of the first embodiment and a capacitor cooled by the coolant;

FIG. 18 is an exploded perspective view schematically illustrating the coolant of the first embodiment and a capacitor cooled by the coolant;

FIG. 19 is a perspective view schematically illustrating the coolant of the first embodiment and a cylindrical heating element cooled by the coolant;

FIG. 20 is a cross-sectional view schematically illustrating a coolant of a second embodiment and a heating element cooled by the coolant;

FIG. 21 is a diagram schematically illustrating a temperature change in a state of the coolant according to the second embodiment;

FIG. 22 is a cross-sectional view schematically illustrating a coolant of a first modification of the second embodiment and a heating element cooled by the coolant;

FIG. 23 is a cross-sectional view schematically illustrating a coolant of a third embodiment;

FIG. 24 is a diagram schematically illustrating a temperature change in a state of a coolant according to a fourth embodiment;

FIG. 25 is a diagram schematically illustrating a state in which a first release polar solvent is accumulated between a first temperature sensitive gel and a second temperature sensitive gel;

FIG. 26 is a diagram schematically illustrating a temperature change in a state of a coolant according to a first modification of the fourth embodiment;

FIG. 27 is a diagram schematically illustrating a temperature change in a state of a coolant of a reference example;

FIG. 28 is a cross-sectional view schematically illustrating a heat pump including a heat pump refrigerant according to a fifth embodiment; and

FIG. 29 is a diagram schematically illustrating a temperature change in a state of a coolant included in the heat pump refrigerant according to the fifth embodiment.

### DETAILED DESCRIPTION

Hereinafter, embodiments of the present disclosure will be described with reference to the drawings. Note that, in the drawings, the same or equivalent elements are denoted by the same reference signs, and redundant description is omitted.

### 1 First Embodiment

### 1.1 Microstructure of Coolant

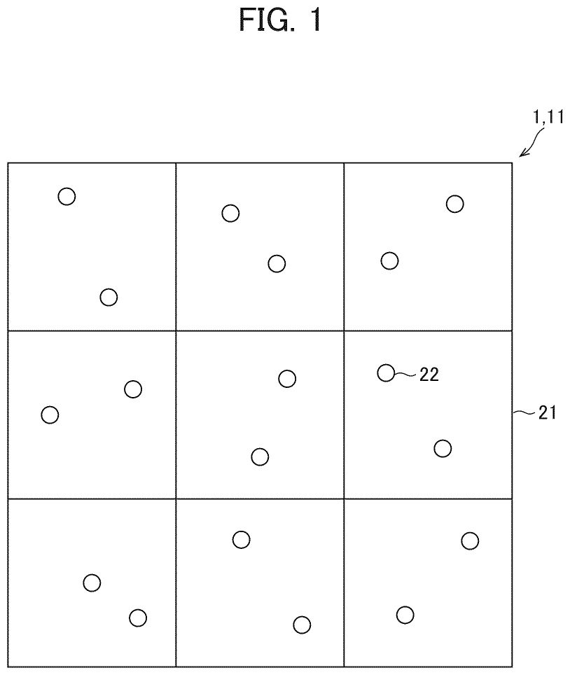

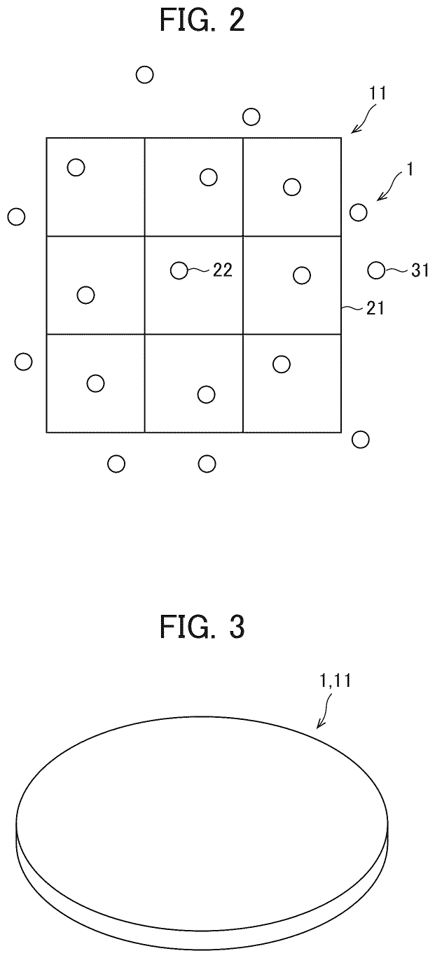

FIG. 1 is a diagram schematically illustrating a microstructure of a coolant of a first embodiment at a temperature lower than a lower critical solution temperature (LCST). FIG. 2 is a diagram schematically illustrating a microstructure of the coolant of the first embodiment at a temperature higher than the LCST.

A coolant 1 of the first embodiment illustrated in FIGS. 1 and 2 comes into contact with a surface of a heating element and absorbs heat from the surface in contact to lower a temperature of the surface or suppress the temperature of the surface from rising.

As illustrated in FIGS. 1 and 2, the coolant 1 includes a temperature sensitive gel 11.

The temperature sensitive gel 11 is a solid having a gel-like property. Therefore, the coolant 1 made of the temperature sensitive gel 11 can be attached to the surface of the heating element. The coolant 1 can also be attached to a surface, such as a surface facing a horizontal direction, on which it is difficult to stably attach a coolant made of a solid having no gel-like property. The temperature sensitive gel 11 attached to the surface comes into contact with the attached surface and is thermally bonded to the heating element.

As illustrated in FIGS. 1 and 2, the temperature sensitive gel 11 contains a temperature sensitive polymer 21 and a polar solvent 22.

In a case where a temperature of the temperature sensitive gel 11 rises above the LCST, a state of the temperature sensitive polymer 21 changes from a predominantly hydrophilic state in which a hydrophilic portion contained in the temperature sensitive polymer 21 is dominant over a hydrophobic portion contained in the temperature sensitive polymer 21 to a predominantly hydrophobic state in which the hydrophobic portion contained in the temperature sensitive polymer 21 is dominant over the hydrophilic portion contained in the temperature sensitive polymer 21. Therefore, the temperature sensitive polymer 21 changes from hydrophilic to hydrophobic.

For this reason, in a case where a temperature rise exceeding the LCST occurs, the temperature sensitive gel 11 causes hydrophobic hydration accompanied by an endothermic reaction, and causes volume phase transition accompanied by an endothermic reaction triggered by the caused hydrophobic hydration. For this reason, the temperature sensitive gel 11 absorbs, from the surface of the heating element, the heat necessary for causing the volume phase transition, that is, the reaction heat of the endothermic reaction accompanying the volume phase transition in a case where the temperature rise exceeding the LCST occurs.

Furthermore, in a case where a temperature rise exceeding the LCST occurs, the fluidity of the polar solvent 22 that has entered a network formed by the temperature sensitive polymer 21 is increased with the hydrophobic hydration as a trigger. Furthermore, a chain of micro condensation of the temperature sensitive polymer 21 causes macro condensation of the temperature sensitive polymer 21. Therefore, a part of the polar solvent 22, which is a component other than the temperature sensitive polymer 21 forming the network, is extruded from the network. Therefore, in a case where the temperature rise exceeding the LCST occurs, the temperature sensitive gel 11 contracts and releases a part (hereinafter, also referred to as “release polar solvent”) 31 of the polar solvent 22 that has wetted the temperature sensitive gel 11. As a result, the temperature sensitive gel 11 absorbs heat necessary for releasing the release polar solvent 31 from the surface of the heating element.

The release polar solvent 31 includes a polar solvent released in a liquid and a polar solvent released in a gas. The reason why the release polar solvent 31 contains a polar solvent that is released as a gas is that the release polar solvent 31 is released as the temperature rises, and thus the release polar solvent 31 is heated when the release polar solvent 31 is released. By virtue of the release polar solvent 31 containing a polar solvent that is released in a gas, the temperature sensitive gel 11 absorbs latent heat from the surface of the heating element that is necessary to evaporate all or part of the release polar solvent 31. All or part of the polar solvent released in a liquid may evaporate. In a case where all or a part of the polar solvent released in a liquid is evaporated, latent heat necessary for evaporating all or part of the polar solvent released in a liquid can be absorbed from the surface of the heating element.

The temperature sensitive gel 11 absorbs not only the reaction heat of the endothermic reaction accompanying the volume phase transition but also the heat necessary for releasing the release polar solvent 31 and the latent heat necessary for evaporating all or part of the release polar solvent 31 from the surface of the heating element. As described above, the temperature sensitive gel 11 absorbs a plurality of types of heat having different properties from each other from the surface of the heating element, so that the temperature of the surface can be effectively lowered or the temperature of the surface can be effectively suppressed from rising. As a result, the temperature sensitive gel 11 can efficiently cool the heating element without requiring a fan, a pump, or the like and occupying a large space.

A part of the release polar solvent 31 may be released from a surface of the temperature sensitive gel 11 in contact with the heating element. However, much of the release polar solvent 31 is released from an opposite side of the temperature sensitive gel 11 that is opposite to a side that is in contact with the heating element. This is because the heat absorbed by the temperature sensitive gel 11 from the heating element is transmitted from the surface in contact with the heating element toward the opposite surface, so that a position of the temperature sensitive gel 11 changing from hydrophilic to hydrophobic also moves from the surface in contact with the heating element toward the opposite surface, and the release polar solvent 31 is also squeezed out from the surface in contact with the heating element toward the opposite surface.

The temperature sensitive gel 11 has a heat capacity larger than a heat capacity of metal. Therefore, a temperature rise of the temperature sensitive gel 11 in a case where the temperature sensitive gel 11 absorbs heat in a heat-insulated closed space is slower than a temperature rise of the metal in a case where the metal absorbs heat in the heat-insulated closed space. Therefore, in a case where the temperature of the heating element continues to rise in the heat-insulated closed space, the temperature sensitive gel 11 can cool the heating element more effectively than metal.

### 1.2 Temperature Sensitive Polymer

The temperature sensitive polymer 21 is a stimulus-responsive polymer having temperature responsiveness. The temperature sensitive polymer 21 has hydrophilicity at a temperature lower than the LCST and has hydrophobicity at a temperature higher than the LCST. The LCST is lower than a temperature reached by the heating element in a case where the heating element generates heat without being cooled by the coolant 1. Therefore, in a case where the heating element generates heat, a temperature rise exceeding the LCST occurs.

The temperature sensitive polymer 21 forms a network. The network may be formed by fixing molecular chains by crosslinking or bonding, or may be formed by entangling molecular chains. The network includes a temperature sensitive component. The temperature sensitive component is a molecule or a unit.

The temperature sensitive polymer 21 contains, for example, at least one selected from the group consisting of:
(1) at least one polymer selected from the group consisting of a cellulose derivative, poly (N-alkyl (meth) acrylamide), a derivative of poly (N-alkyl (meth) acrylamide), poly (N-vinylalkylamide), a derivative of poly (N-vinylalkylamide), poly (N-vinylpyrrolidone), a derivative of poly (N-vinylpyrrolidone), poly (2-alkyl-2-oxazoline), a derivative of poly (2-alkyl-2-oxazoline), polyvinyl ether, a derivative of polyvinyl ether, polyvinyl alkyl ether, a derivative of polyvinyl alkyl ether, a copolymer of polyethylene oxide and polypropylene oxide, a derivative of a copolymer of polyethylene oxide and polypropylene oxide, poly (oxyethylene vinyl ether) and a derivative of poly (oxyethylene vinyl ether);
(2) a copolymer of at least two polymers selected from the group; and
(3) a crosslinked body of at least one polymer selected from the group consisting of the at least one polymer and the copolymer of the at least two polymers.

The cellulose derivative contains, for example, at least one selected from the group consisting of methyl cellulose, ethyl cellulose, hydroxypropyl cellulose, and hydroxypropyl methyl cellulose.

The poly (N-alkyl (meth) acrylamide) contains, for example, at least one selected from the group consisting of poly (N-isopropyl (meth) acrylamide), poly (N-normal propyl (meth) acrylamide), poly (N-methyl (meth) acrylamide), poly (N-ethyl (meth) acrylamide), poly (N-normal butyl (meth) acrylamide), poly (N-isobutyl (meth) acrylamide), and poly (N-t-butyl (meth) acrylamide).

The poly (N-vinylalkylamide) contains, for example, at least one selected from the group consisting of poly (N-vinylisopropylamide), poly (N-vinyl normal propylamide), poly (N-vinyl normal butylamide), poly (N-vinylisobutylamide), and poly (N-vinyl-t-butylamide).

The poly (2-alkyl-2-oxazoline) contains, for example, at least one selected from the group consisting of poly (2-ethyl-2-oxazoline), poly (2-isopropyl-2-oxazoline), and poly (2-normal propyl-2-oxazolinc).

The polyvinyl alkyl ether includes, for example, at least one selected from the group consisting of polyvinyl methyl ether and polyvinyl ethyl ether.

Here, “(meth) acrylic” means “acrylic” or “methacrylic”.

The LCST of the temperature sensitive polymer 21 varies depending on the type of the temperature sensitive polymer 21. For example, in a case where the temperature sensitive polymer 21 is poly (N-isopropylacrylamide) (PNIPAM), the LCST of the temperature sensitive polymer 21 is 32° C. In a case where the temperature sensitive polymer 21 is hydroxypropyl cellulose (HPC), the LCST of the temperature sensitive polymer 21 is 45° C. to 46° C. In a case where the temperature sensitive polymer 21 is poly (N-cyclopropylacrylamide) (PNCPAM), the LCST of the temperature sensitive polymer 21 is 49° C. In a case where the temperature sensitive polymer 21 is poly (2-ethyl-2-oxazoline) (PEtOx), the LCST of the temperature sensitive polymer 21 is 62° C. to 65° C.

The temperature sensitive polymer 21 has a molecular structure having a hydrophobic group and a hydrophilic group and has amphiphilicity. The LCST of the temperature sensitive polymer 21 can be changed by substituting both or one of the hydrophobic group and the hydrophilic group.

The LCST of the temperature sensitive polymer 21 is affected by an actual use environment such as pH and an ion amount. Therefore, the temperature sensitive polymer 21 is designed in consideration of the actual use environment.

### 1.3 Polar Solvent

The polar solvent 22 enters the network formed by the temperature sensitive polymer 21 to wet the temperature sensitive polymer 21.

The polar solvent 22 contains, for example, at least one selected from the group consisting of water and a polar solvent having flame retardancy. The polar solvent having flame retardancy includes, for example, an ionic liquid. The ionic liquid includes, for example, an imidazolium salt. The imidazolium salt contains, for example, at least one selected from the group consisting of an imidazolium salt represented by Chemical Formula (1) and an imidazolium salt represented by Chemical Formula (2). In Chemical Formula (1), R¹, R², and R³ are each an alkyl group having 1 to 12 carbon atoms, and X is halogen. In Chemical Formula (2), R¹ is an alkyl group having 1 to 6 carbon atoms, R² is a group represented by Chemical Formula (3), and X is Cl, Br, BF₄, BPh₄, PF₆, NO₃, [(CF₃SO₂)₂N] or [(CN)₂N]. In Chemical Formula (3), A is a direct bond, a phenylene group, or a group represented by Chemical Formula (4).

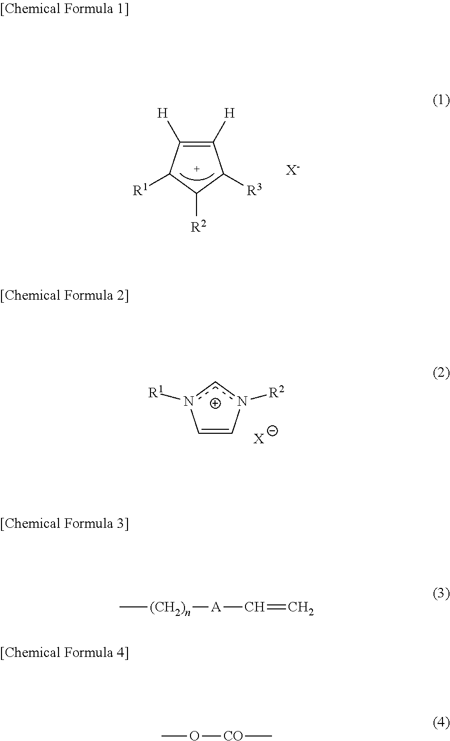

### 1.4 Hydrophilic Polymer

The temperature sensitive gel 11 may contain a hydrophilic polymer. In a case where the temperature sensitive gel 11 contains a hydrophilic polymer, the affinity of the temperature sensitive gel 11 with a polar solvent can be increased.

The hydrophilic polymer contains, for example, at least one selected from the group consisting of:
(1) at least one polymer selected from the group consisting of polyethylene glycol (PEG), 2-methacryloyloxyethyl phosphorylcholine (MPC), poly (meth) acrylic acid, poly (meth) acrylate, alginic acid, alginate, hyaluronic acid, hyaluronic acid salt, chitosan, and a cellulose derivative;
(2) a copolymer of at least two polymers selected from the group; and
(3) a crosslinked body of at least one polymer selected from the group consisting of the at least one polymer and the copolymer of the at least two polymers.

The cellulose derivative contains, for example, at least one selected from the group consisting of carboxymethyl cellulose, methyl cellulose, ethyl cellulose, and hydroxyethyl cellulose.

Here, “(meth) acrylic” means “acrylic” or “methacrylic”.

In a case where the temperature sensitive gel 11 contains a hydrophilic polymer, the volume phase transition can often be made into a gradual phase transition by randomly copolymerizing the temperature sensitive polymer 21 and the hydrophilic polymer. Furthermore, it is often possible to substantially maintain the LCST of the temperature sensitive polymer 21 by imparting an interpenetrating polymer network (IPN) structure to the temperature sensitive polymer 21 and the hydrophilic polymer.

### 1.5 Production of Temperature Sensitive Gel

In a case where the temperature sensitive gel 11 is produced, for example, a solution containing a pre-crosslinking precursor of the temperature sensitive polymer 21 and the polar solvent 22 is prepared, and a gelation treatment such as a treatment of crosslinking the pre-crosslinking precursor is performed on the prepared solution.

### 1.6 Shape of Coolant

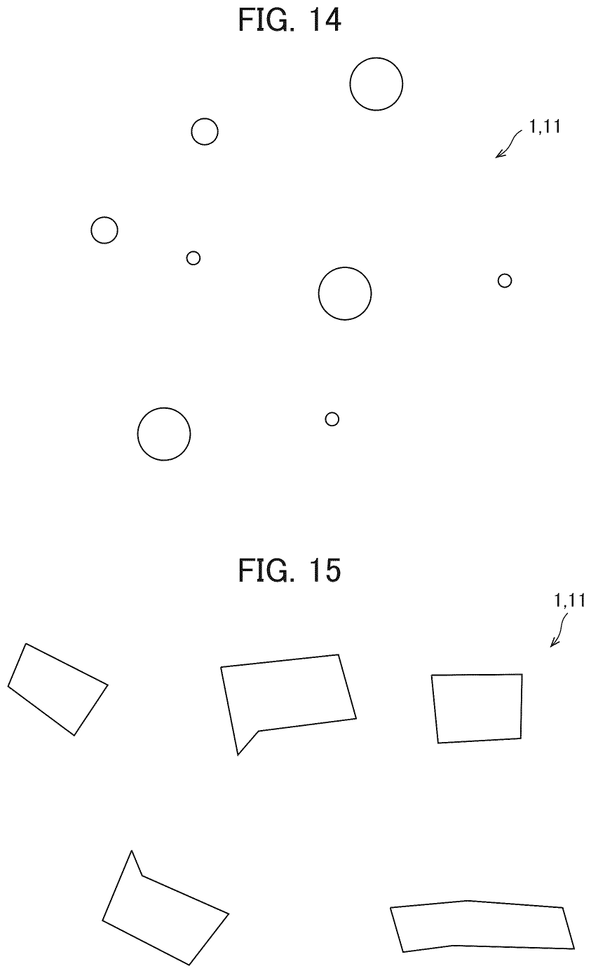

FIGS. 3 to 13 are perspective views schematically illustrating examples of the shape of the coolant of the first embodiment. FIGS. 14 and 15 are plan views schematically illustrating examples of shapes of the coolant according to the first embodiment.

The coolant 1 may have any shape. A shape suitable for the use of the coolant 1 is imparted to the coolant 1.

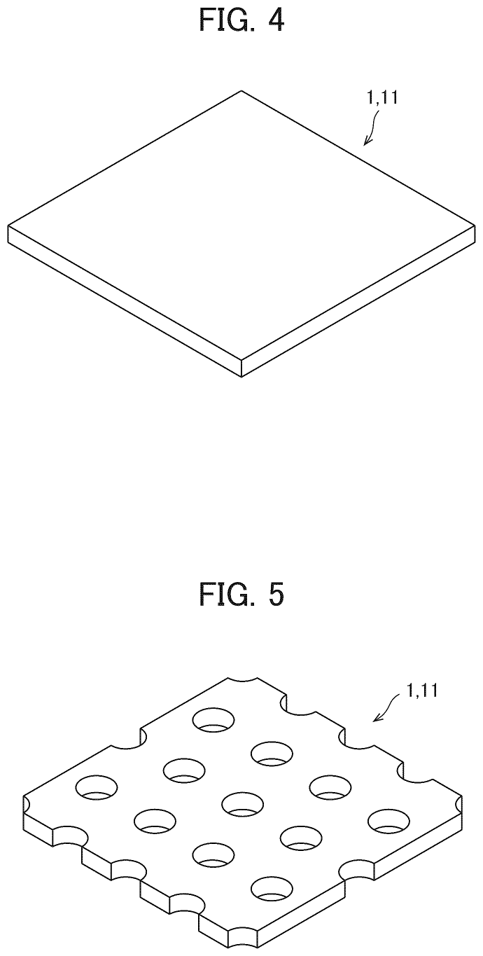

For example, the coolant 1 may have a disk shape illustrated in FIG. 3, a rectangular plate shape illustrated in FIG. 4, or the like. The coolant 1 may have a flat plate shape other than the disk shape and the rectangular plate shape. In a case where the coolant 1 has a flat plate shape, an area of a surface of the coolant 1 in contact with the heating element can be increased. Therefore, in a case where the coolant 1 has a flat plate shape, the heating element having a surface having a large area can be efficiently cooled. Therefore, in a case where it is desired to cool a wide range in an open space, it is desirable to impart a flat plate shape to the coolant 1.

Alternatively, the coolant 1 may have a plate-like or cloth-like outer shape illustrated in FIG. 5 and a shape in which a plurality of holes are formed. In a case where the coolant 1 has the shape, a wide range can be cooled even when an amount of the temperature sensitive gel 11 included in the coolant 1 is small.

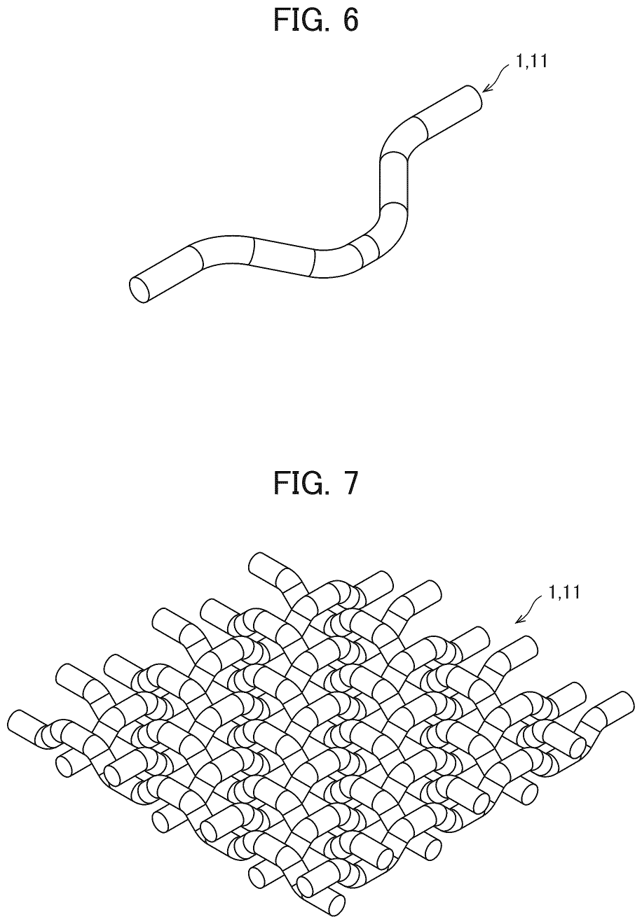

Alternatively, the coolant 1 may have a thread-like or string-like shape illustrated in FIG. 6. In a case where the coolant 1 has a thread-like or string-like shape, the coolant 1 can be brought into contact with the heating element by winding the coolant 1 around the surface of the heating element, filling the inside of the heating element with the coolant 1, or the like. In a case where the coolant 1 has a thread-like or string-like shape, since the entire coolant 1 is connected, the entire coolant 1 can be drawn by drawing one end of the coolant 1. Therefore, in a case where the coolant 1 has a thread-like or string-like shape, the coolant 1 can be easily replaced when the coolant 1 deteriorates.

Alternatively, the coolant 1 may have a mesh shape illustrated in FIG. 7. Even in a case where the coolant 1 has a mesh shape, the heating element having a surface having a large area can be efficiently cooled. In a case where the coolant 1 has a mesh shape, the coolant 1 may be a cloth-like woven fabric made of a plurality of interwoven yarns. In a case where each of the yarns has the core-sheath structure described below, the coolant 1 has the same effect as the effect of the core-sheath structure described below. The plurality of yarns may be one type of yarn or two or more types of yarns. Two or more types of yarns may have LCSTs different from each other. In a case where two or more types of yarns have LCSTs different from each other, the coolant 1 contracts by causing a volume phase transition accompanied by an endothermic reaction in a case where a temperature rise exceeding each of two or more different LCSTs occurs. For this reason, although a cooling rate decreases, a cooling capacity can be maintained for a long time. The coolant 1 may be a laminate of a plurality of coolant having a mesh shape. In a case where the coolant 1 is the laminate, the cooling rate can be increased.

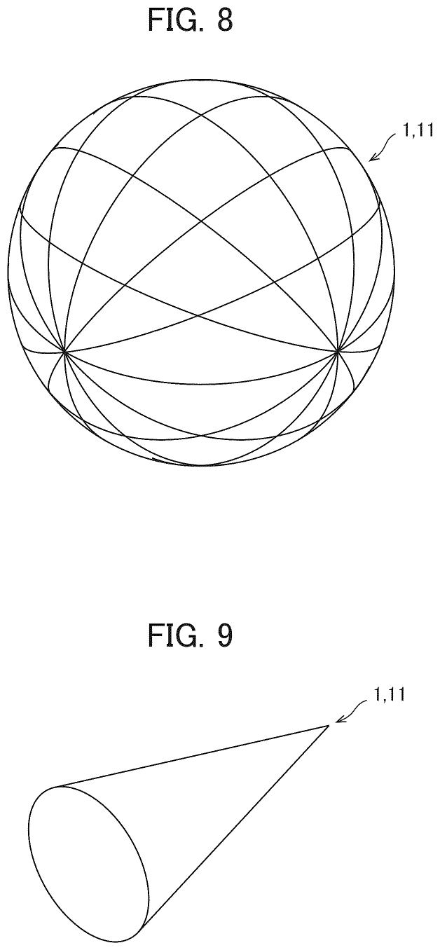

Alternatively, the coolant 1 may have a spherical shape illustrated in FIG. 8.

Alternatively, the coolant 1 may have a conical shape or the like illustrated in FIG. 9. The coolant 1 may have a conical shape other than the conical shape.

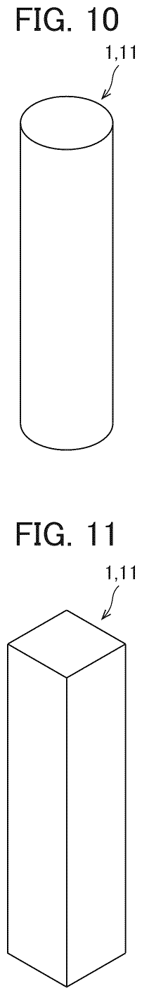

Alternatively, the coolant 1 may have a round rod shape illustrated in FIG. 10, a square rod shape illustrated in FIG. 11, or the like. The coolant 1 may have a rod shape other than the round rod shape and the square rod shape.

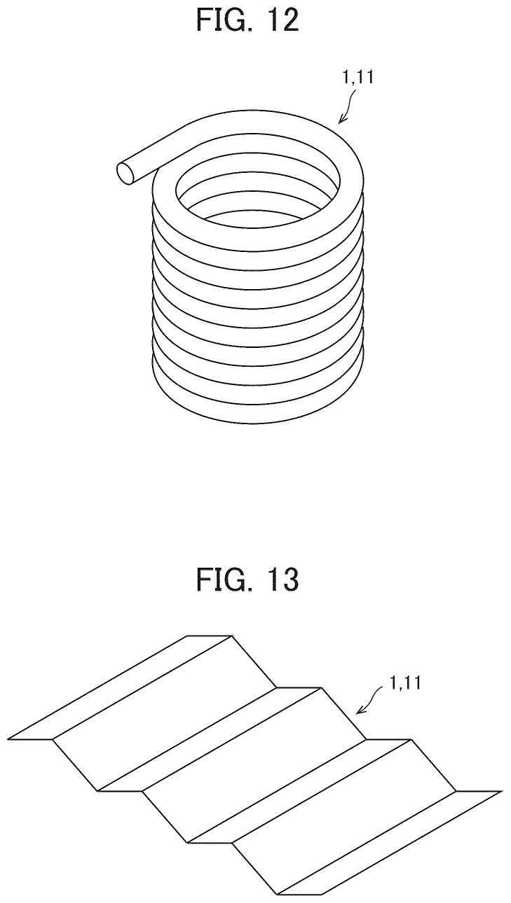

Alternatively, the coolant 1 may have a coil shape illustrated in FIG. 12. In a case where the coolant 1 has a coil shape, the coolant 1 can be formed by winding a coolant having a thread-like shape.

Alternatively, the coolant 1 may have a shape of a folding screen illustrated in FIG. 13.

Alternatively, the coolant 1 may have a granular shape illustrated in FIG. 14 or a pulverized shape illustrated in FIG. 15. In a case where the coolant 1 has a pulverized shape, the coolant 1 can be formed by pulverizing the coolant having a flat plate shape to obtain a solid. In a case where the coolant 1 has a pulverized shape, the coolant 1 has an irregular shape, for example, a block shape, a flake shape, or the like. In a case where the coolant 1 has a granular shape or a pulverized shape, the coolant 1 can be brought into contact with the heating element by filling the inside of the heating element with the coolant 1. Therefore, in a case where it is desired to cool a narrow range in a closed space such as a tube or the inside of an electronic component, desirably, a granular shape or a pulverized shape is imparted to the coolant 1.

In a case where the coolant 1 cools the heating element in the closed space, a fan that generates an air flow that hits the coolant 1 and the heating element is desirably installed. As a result, the coolant 1 can efficiently cool the heating element. In a case where the coolant 1 cools the heating element in the open space, the coolant 1 can efficiently cool the heating element.

### 1.7 Examples of Use of Coolant

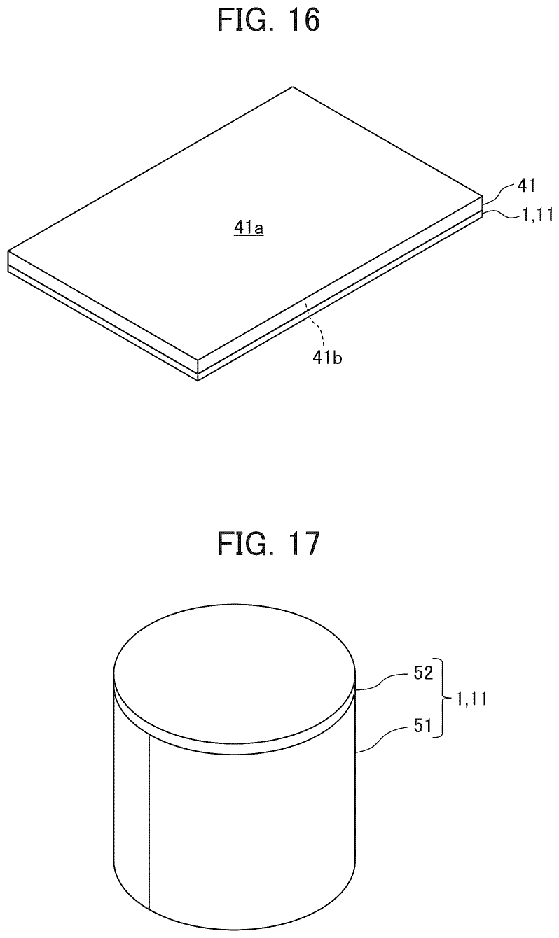

FIG. 16 is a perspective view schematically illustrating the coolant of the first embodiment and a circuit board cooled by the coolant.

A circuit board 41 illustrated in FIG. 16 is a heating element having a flat plate shape. Therefore, the circuit board 41 includes a first principal surface 41a and a second principal surface 41b. The first principal surface 41a and the second principal surface 41b are on opposite sides.

The coolant 1 illustrated in FIG. 16 has a flat plate shape and is attached to the second principal surface 41b of the circuit board 41. As a result, the coolant 1 comes into contact with the second principal surface 41b to cool the circuit board 41. Instead of the coolant 1 attached to the second principal surface 41b, or in addition to the coolant 1 attached to the second principal surface 41b, a coolant attached to the first principal surface 41a may be provided.

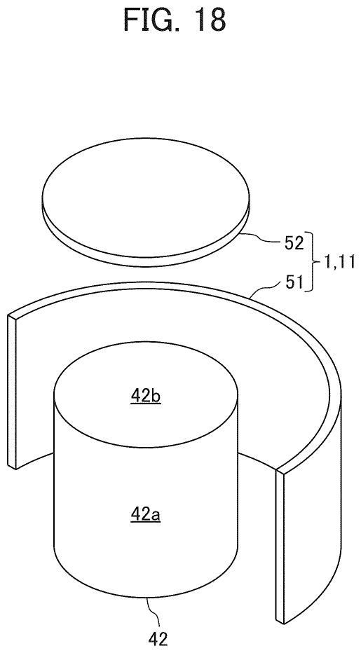

FIG. 17 is a perspective view schematically illustrating the coolant of the first embodiment and a capacitor cooled by the coolant. FIG. 18 is an exploded perspective view schematically illustrating the coolant of the first embodiment and a capacitor cooled by the coolant.

A capacitor 42 illustrated in FIGS. 17 and 18 is a heating element having a cylindrical shape. Therefore, the capacitor 42 has an outer peripheral surface 42a and a top surface 42b.

The coolant 1 illustrated in FIGS. 17 and 18 includes a first portion 51 and a second portion 52. The first portion 51 has a sheet-like shape, has flexibility, is wound around the outer peripheral surface 42a of the capacitor 42, and is attached to the outer peripheral surface 42a. As a result, the first portion 51 comes into contact with the outer peripheral surface 42a to cool the capacitor 42. The second portion 52 has a sheet-like shape and is attached to the top surface 42b of the capacitor 42. As a result, the second portion 52 comes into contact with the top surface 42b to cool the capacitor 42.

FIGS. 17 and 18 illustrate a state in which the coolant 1 is in contact with the entire outer peripheral surface 42a and the entire top surface 42b of the capacitor 42 to cool the capacitor 42. However, the coolant 1 may be brought into contact with only part of the outer peripheral surface 42a and the top surface 42b of the capacitor 42 to cool the capacitor 42.

The coolant 1 may cool electronic components other than the capacitor 42 having a cylindrical shape.

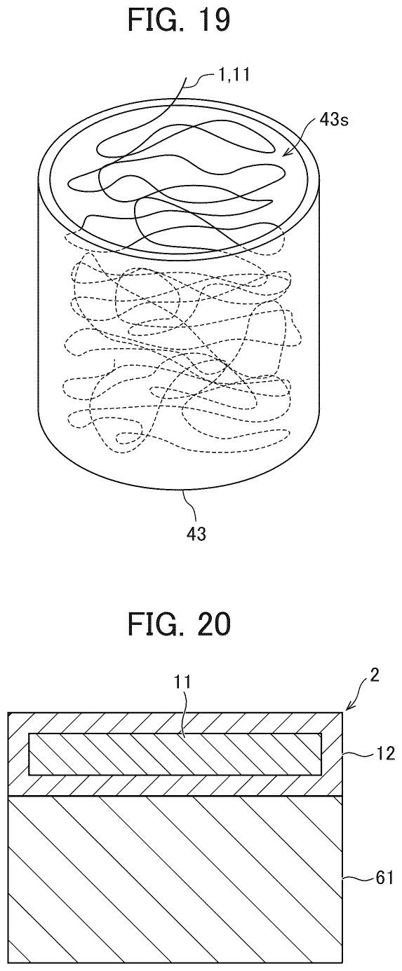

FIG. 19 is a perspective view schematically illustrating the coolant of the first embodiment and a cylindrical heating element cooled by the coolant.

A cylindrical heating element 43 illustrated in FIG. 19 has a cylindrical shape. Therefore, an in-cylinder space 43s is formed inside the cylindrical heating element 43.

The coolant 1 illustrated in FIG. 19 has a thread-like shape. The in-cylinder space 43s of the cylindrical heating element 43 is filled with the coolant 1. In a case where the coolant 1 has a thread-like shape, the entire coolant 1 can be easily taken out of the in-cylinder space 43s by pulling one end of the coolant 1 when the coolant 1 needs to be replaced with a new coolant. Therefore, the coolant 1 can be easily replaced with a new coolant. In a case where the in-cylinder space 43s is filled with the coolant 1, the coolant 1 may have a granular or pulverized shape. The coolant 1 may be filled in a space formed in a heating element other than the cylindrical heating element 43 or an object in contact with the heating element. For example, the coolant 1 may be filled in a hole formed in a box-shaped heating element, a shallow rectangular heating element, a housing of a container in contact with the heating element, or the like.

In a case where the temperature sensitive gel 11 is attached to the heating element, the temperature sensitive gel 11 is fixed to the heating element by a fixing member such as an adhesive, a tape, a screw, or a wire. In a case where the temperature sensitive gel 11 is fixed to the heating element by a fixing member disposed between the temperature sensitive gel 11 and the heating element, such as an adhesive or a tape, the fixing member is desirably interspersed on a facing surface of the temperature sensitive gel 11 facing the heating element. As a result, it is possible to suppress the cooling from being obstructed by the fixing member as compared with a case where the fixing member is disposed on the entire facing surface. Alternatively, in a case where the temperature sensitive gel 11 is attached to the heating element, the temperature sensitive gel 11 is fixed to the heating element by a chemical bond such as silane coupling.

The coolant 1 is used at a temperature lower than a combustion temperature of the temperature sensitive polymer 21. For example, in a case where the temperature sensitive polymer 21 is a cellulose derivative having a combustion temperature of 200° C. or higher, the coolant 1 is generally used at 150° C. or lower.

### 2 Second Embodiment

Hereinafter, differences between a second embodiment and the first embodiment will be described. Regarding points that are not described, a configuration similar to the configuration adopted in the first embodiment is also adopted in the second embodiment.

FIG. 20 is a cross-sectional view schematically illustrating a coolant of the second embodiment and a heating element cooled by the coolant.

A coolant 2 of the second embodiment illustrated in FIG. 20 includes a temperature sensitive gel 11 and an impermeable layer 12.

The impermeable layer 12 covers the temperature sensitive gel 11. The impermeable layer 12 covers the entire surface of the temperature sensitive gel 11 and is in contact with the entire surface of the temperature sensitive gel 11. The impermeable layer 12 has hydrophobicity or waterproofness. Therefore, the impermeable layer 12 does not allow a polar solvent 22 to permeate therethrough. As a result, the temperature sensitive gel 11 is accommodated in a space surrounded by the impermeable layer 12. Furthermore, it is possible to suppress a release polar solvent 31 released by the temperature sensitive gel 11 from leaking from the inside of the space to the outside of the space. The release polar solvent 31 is confined in the space and retained between the temperature sensitive gel 11 and the impermeable layer 12. The retained release polar solvent 31 is absorbed by the temperature sensitive gel 11 in a case where a temperature drop above the LCST occurs. As a result, the coolant 2 can be repeatedly used for cooling.

The impermeable layer 12 contains, for example, at least one selected from the group consisting of polyvinylidene chloride, silicone gel, polyethylene, and polyurethane.

In a case where the impermeable layer 12 has adhesiveness, the coolant 2 can be attached to a heating element 61 by attaching the impermeable layer 12 to the heating element 61 using the adhesiveness. Therefore, in a case where the impermeable layer 12 has adhesiveness, a fixing member such as an adhesive for fixing the coolant 2 to the heating element 61 is unnecessary.

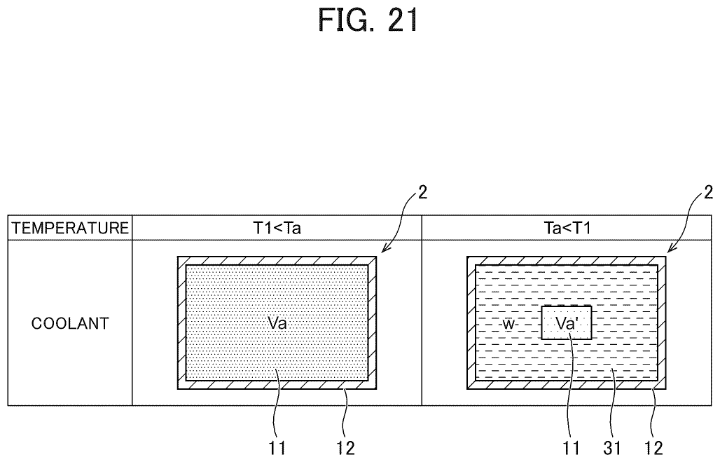

FIG. 21 is a diagram schematically illustrating a temperature change in a state of the coolant of the second embodiment.

As illustrated in FIG. 21, in a case where a temperature T1 of the heating element 61 is lower than an LCST (Ta) of the temperature sensitive gel 11, the temperature sensitive gel 11 holds the polar solvent 22 without releasing it, and has a volume Va. Therefore, the polar solvent 22 is not present between the temperature sensitive gel 11 and the impermeable layer 12.

In a case where the temperature T1 of the heating element 61 is higher than the LCST (Ta) of the temperature sensitive gel 11, the temperature sensitive polymer 21 included in the temperature sensitive gel 11 changes from hydrophilic to hydrophobic. Therefore, the temperature sensitive gel 11 contracts and has a volume Va′ smaller than the volume Va. The temperature sensitive gel 11 then releases the release polar solvent 31. The release polar solvent 31 is accumulated between the temperature sensitive gel 11 and the impermeable layer 12 and has a volume w.

In a case where the temperature T1 of the heating element 61 becomes lower than the LCST (Ta) of the temperature sensitive gel 11 again, the temperature sensitive gel 11 swells to have the volume Va again. At this time, the temperature sensitive gel 11 absorbs the accumulated release polar solvent 31. Therefore, the release polar solvent 31 does not exist between the temperature sensitive gel 11 and the impermeable layer 12.

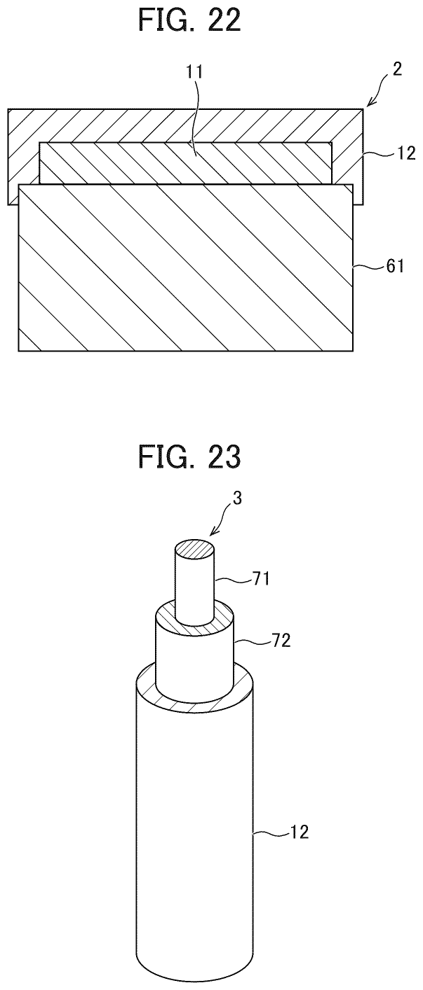

FIG. 22 is a cross-sectional view schematically illustrating a coolant of a first modification of the second embodiment and a heating element cooled by the coolant.

In the first modification of the second embodiment, as illustrated in FIG. 22, the impermeable layer 12 covers the temperature sensitive gel 11. The impermeable layer 12 covers a part of the surface of the temperature sensitive gel 11 and contacts a part of the surface of the temperature sensitive gel 11. The heating element 61 covers a remaining portion of the surface of the temperature sensitive gel 11 and contacts the remaining portion of the surface of the temperature sensitive gel 11. As a result, the temperature sensitive gel 11 is accommodated in a space surrounded by the impermeable layer 12 and the heating element 61. Furthermore, it is possible to suppress a release polar solvent 31 released by the temperature sensitive gel 11 from leaking from the inside of the space to the outside of the space. The release polar solvent 31 is confined in the space and retained between the temperature sensitive gel 11 and the impermeable layer 12 or between the temperature sensitive gel 11 and the heating element 61. The retained release polar solvent 31 is absorbed by the temperature sensitive gel 11 in a case where a temperature drop above the LCST occurs. As a result, the coolant 2 can be repeatedly used for cooling.

### 3 Third Embodiment

Hereinafter, differences between a third embodiment and the first embodiment will be described. Regarding points that are not described, a configuration similar to the configuration adopted in the first embodiment is also adopted in the third embodiment.

FIG. 23 is a cross-sectional view schematically illustrating a coolant of a third embodiment.

A coolant 3 of the third embodiment illustrated in FIG. 23 has a thread-like shape.

As illustrated in FIG. 23, the coolant 3 includes a first temperature sensitive gel 71, a second temperature sensitive gel 72, and an impermeable layer 12.

The first temperature sensitive gel 71 contains a first temperature sensitive polymer and a first polar solvent similarly to the temperature sensitive gel 11 included in the coolant 1 of the first embodiment. The first temperature sensitive polymer has hydrophilicity at a temperature lower than a first LCST, and has hydrophobicity at a temperature higher than the first LCST. The first polar solvent wets the first temperature sensitive polymer. The first temperature sensitive gel 71 undergoes a first volume phase transition with an endothermic reaction in a case where a temperature rise exceeding the first LCST occurs. The first temperature sensitive gel 71 contracts to release a part of the first polar solvent (hereinafter also referred to as “first release polar solvent”) in a case where a temperature rise exceeding the first LCST occurs.

The second temperature sensitive gel 72 contains a second temperature sensitive polymer and a second polar solvent similarly to the temperature sensitive gel 11 included in the coolant 1 of the first embodiment. The second temperature sensitive polymer has hydrophilicity at a temperature lower than a second LCST, and has hydrophobicity at a temperature higher than the second LCST. The second polar solvent wets the second temperature sensitive polymer. The second temperature sensitive gel 72 undergoes a second volume phase transition with an endothermic reaction in a case where a temperature rise exceeding the second LCST occurs. The second temperature sensitive gel 72 contracts and releases a part of the second polar solvent (hereinafter also referred to as “second release polar solvent”) in a case where a temperature rise exceeding the second LCST occurs.

The first LCST of the first temperature sensitive gel 71 and the second LCST of the second temperature sensitive gel 72 are different from each other. The first LCST and the second LCST may be made different from each other by making the first temperature sensitive polymer and the second temperature sensitive polymer respectively included in the first temperature sensitive gel 71 and the second temperature sensitive gel 72 different from each other or not. Therefore, the first temperature sensitive polymer and the second temperature sensitive polymer may or may not be polymers obtained by crosslinking the same type of polymer with the same type of crosslinking agent.

The first temperature sensitive gel 71 and the second temperature sensitive gel 72 are in contact with each other.

The coolant 3 has a core-sheath structure. The first temperature sensitive gel 71 constitutes a core. The second temperature sensitive gel 72 constitutes a sheath covering the core. Therefore, the first temperature sensitive gel 71 has a thread-like shape. The second temperature sensitive gel 72 covers the outer peripheral surface of the first temperature sensitive gel 71 and contacts the outer peripheral surface of the first temperature sensitive gel 71.

The impermeable layer 12 covers the sheath. Therefore, the impermeable layer 12 covers the outer peripheral surface of the second temperature sensitive gel 72 and contacts the outer peripheral surface of the second temperature sensitive gel 72. The impermeable layer 12 has hydrophobicity or waterproofness. Therefore, the impermeable layer 12 does not allow permeation of a first polar solvent and a second polar solvent included in the first temperature sensitive gel 71 and the second temperature sensitive gel 72, respectively. As a result, the first temperature sensitive gel 71 and the second temperature sensitive gel 72 are accommodated in a space surrounded by the impermeable layer 12. Furthermore, it is possible to suppress leakage of the first release polar solvent and the second release polar solvent respectively released by the first temperature sensitive gel 71 and the second temperature sensitive gel 72 from the inside of the space to the outside of the space. As a result, the coolant 3 can be repeatedly used for cooling.

The impermeable layer 12 contains, for example, at least one selected from the group consisting of polyvinylidene chloride, silicone gel, polyethylene, and polyurethane.

The second LCST of the second temperature sensitive gel 72 is lower than the first LCST of the first temperature sensitive gel 71. The second LCST is made lower than the first LCST by imparting strong hydrophilicity to the first temperature sensitive polymer of the first temperature sensitive gel 71 to increase the first LCST and imparting weak hydrophilicity to the second temperature sensitive polymer of the second temperature sensitive gel 72 to decrease the second LCST. The first LCST can be adjusted by adjusting the LCST of the first temperature sensitive gel 71 itself by selecting the first temperature sensitive gel 71, adjusting the ion concentration, adjusting the pH, and the like. The second LCST can also be adjusted by adjusting the LCST of the second temperature sensitive gel 72 itself by selecting the second temperature sensitive gel 72, adjusting the ion concentration, adjusting the pH, and the like.

In a case where a temperature rise exceeding the second LCST (Tb) of the second temperature sensitive gel 72 occurs, the second temperature sensitive polymer included in the second temperature sensitive gel 72 changes from hydrophilic to hydrophobic. The change from hydrophilicity to hydrophobicity of the second temperature sensitive polymer occurs before a change from hydrophilicity to hydrophobicity of the first temperature sensitive polymer included in the first temperature sensitive gel 71. As a result, the second temperature sensitive gel 72 becomes a wall that does not allow the first release polar solvent released by the first temperature sensitive gel 71 to permeate therethrough. This makes it possible to suppress leakage of the first release polar solvent to the outside of the coolant 3. When the second temperature sensitive polymer changes from hydrophilic to hydrophobic, the second temperature sensitive gel 72 releases the second release polar solvent. The second release polar solvent contains a polar solvent released from the inner peripheral surface of the second temperature sensitive gel 72 and a polar solvent released from the outer peripheral surface of the second temperature sensitive gel 72. The former polar solvent is absorbed by the first temperature sensitive gel 71. Therefore, when the second temperature sensitive gel 72 changes from hydrophilic to hydrophobic, the first temperature sensitive gel 71 expands. The latter polar solvent is accumulated between the outer peripheral surface of the second temperature sensitive gel 72 and the inner peripheral surface of the impermeable layer 12.

In a case where a temperature rise exceeding the first LCST of the first temperature sensitive gel 71 occurs after a temperature rise exceeding the second LCST of the second temperature sensitive gel 72 occurs, the first temperature sensitive polymer included in the first temperature sensitive gel 71 changes from hydrophilic to hydrophobic. When the first temperature sensitive polymer changes from hydrophilic to hydrophobic, the first temperature sensitive gel 71 releases the first release polar solvent. The released first release polar solvent is released from the outer peripheral surface of the first temperature sensitive gel 71. The released first release polar solvent accumulates between the outer peripheral surface of the first temperature sensitive gel 71 and the inner peripheral surface of the second temperature sensitive gel 72.

As a result, the coolant 3 not only absorbs the heat corresponding to the heat capacity of the coolant 3 from the heating element, but also absorbs the heat necessary for the endothermic reaction accompanying the first volume phase transition and the second volume phase transition respectively caused by the first temperature sensitive gel 71 and the second temperature sensitive gel 72 from the surface of the heating element, and absorbs the heat necessary for the first temperature sensitive gel 71 and the second temperature sensitive gel 72 to release the first release polar solvent and the second release polar solvent respectively from the surface of the heating element.

The first release polar solvent and the second release polar solvent released by the first temperature sensitive gel 71 and the second temperature sensitive gel 72, respectively, do not permeate the impermeable layer 12. Therefore, the first release polar solvent and the second release polar solvent remain inside the coolant 3 and do not leak out of the coolant 3. The first polar release solvent and the second release polar solvent remaining inside the coolant 3 are absorbed by the second temperature sensitive gel 72 in a case where a temperature drop exceeding the second LCST of the second temperature sensitive gel 72 occurs, and are absorbed by the first temperature sensitive gel 71 in a case where a temperature drop exceeding the first LCST of the first temperature sensitive gel 71 occurs. As a result, the coolant 3 does not lose the first polar solvent and the second polar solvent included in the first temperature sensitive gel 71 and the second temperature sensitive gel 72, respectively. As a result, the coolant 3 can be repeatedly used.

The impermeable layer 12 may be omitted. In a case where the impermeable layer 12 is omitted, the second release polar solvent released from the outer peripheral surface of the second temperature sensitive gel 72 contains a polar solvent released in a gas. As a result, the coolant 3 absorbs heat necessary for evaporating the polar solvent released by the gas from the surface of the heating element.

### 4 Fourth Embodiment

Hereinafter, differences between a fourth embodiment and the first embodiment will be described. Regarding the points not described, the same configuration as the configuration adopted in the first embodiment is also adopted in the fourth embodiment.

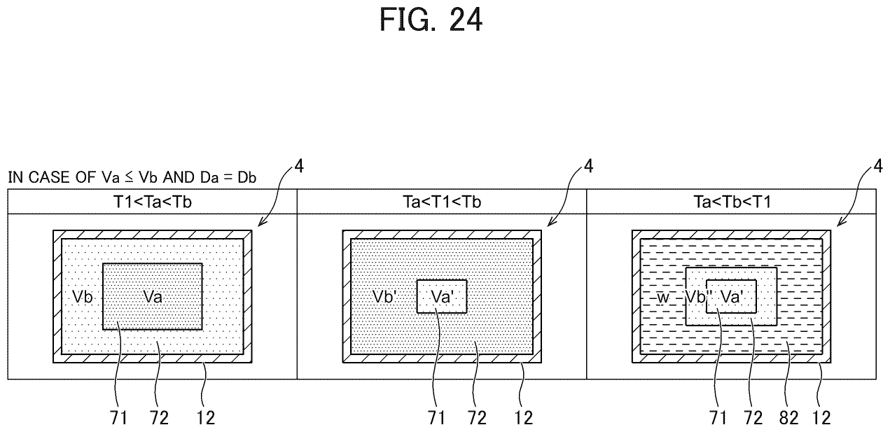

FIG. 24 is a diagram schematically illustrating a temperature change in a state of a coolant according to the fourth embodiment.

A coolant 4 of the fourth embodiment illustrated in FIG. 24 includes a first temperature sensitive gel 71, a second temperature sensitive gel 72, and an impermeable layer 12.

The first temperature sensitive gel 71 contains a first temperature sensitive polymer and a first polar solvent similarly to the temperature sensitive gel 11 included in the coolant 1 of the first embodiment. The first temperature sensitive polymer has hydrophilicity at a temperature lower than a first LCST, and has hydrophobicity at a temperature higher than the first LCST. The first polar solvent wets the first temperature sensitive polymer. The first temperature sensitive gel 71 undergoes a first volume phase transition with an endothermic reaction in a case where a temperature rise exceeding the first LCST occurs. The first temperature sensitive gel 71 contracts to release a part of the first polar solvent (hereinafter also referred to as “first release polar solvent”) in a case where a temperature rise exceeding the first LCST occurs.

The second temperature sensitive gel 72 contains a second temperature sensitive polymer and a second polar solvent similarly to the temperature sensitive gel 11 included in the coolant 1 of the first embodiment. The second temperature sensitive polymer has hydrophilicity at a temperature lower than a second LCST, and has hydrophobicity at a temperature higher than the second LCST. The second polar solvent wets the second temperature sensitive polymer. The second temperature sensitive gel 72 undergoes a second volume phase transition with an endothermic reaction in a case where a temperature rise exceeding the second LCST occurs. The second temperature sensitive gel 72 contracts and releases a part of the second polar solvent (hereinafter also referred to as “second release polar solvent”) in a case where a temperature rise exceeding the second LCST occurs.

The first LCST of the first temperature sensitive gel 71 and the second LCST of the second temperature sensitive gel 72 are different from each other. The first LCST and the second LCST may be made different from each other by making the first temperature sensitive polymer and the second temperature sensitive polymer respectively included in the first temperature sensitive gel 71 and the second temperature sensitive gel 72 different from each other or not. Therefore, the first temperature sensitive polymer and the second temperature sensitive polymer may or may not be polymers obtained by crosslinking the same type of polymer with the same type of crosslinking agent.

The first temperature sensitive gel 71 and the second temperature sensitive gel 72 are in contact with each other.

The second temperature sensitive gel 72 envelops the first temperature sensitive gel 71. The second temperature sensitive gel 72 covers the entire surface of the first temperature sensitive gel 71. The second temperature sensitive gel 72 may be in contact with only a part of the surface of the first temperature sensitive gel 71 without enveloping the first temperature sensitive gel 71.

The impermeable layer 12 envelops the second temperature sensitive gel 72. The impermeable layer 12 covers the entire surface of the second temperature sensitive gel 72 and is in contact with the entire surface of the second temperature sensitive gel 72. The impermeable layer 12 has hydrophobicity or waterproofness. Therefore, the impermeable layer 12 does not allow permeation of the first polar solvent and the second polar solvent included in the first temperature sensitive gel 71 and the second temperature sensitive gel 72, respectively. As a result, the first temperature sensitive gel 71 and the second temperature sensitive gel 72 are accommodated in a space surrounded by the impermeable layer 12. Furthermore, it is possible to suppress leakage of the first release polar solvent and the second release polar solvent respectively released by the first temperature sensitive gel 71 and the second temperature sensitive gel 72 from the inside of the space to the outside of the space. As a result, the coolant 4 can be repeatedly used for cooling.

The impermeable layer 12 contains, for example, at least one selected from the group consisting of polyvinylidene chloride, silicone gel, polyethylene, and polyurethane.

The second LCST (Tb) of the second temperature sensitive gel 72 is higher than the first LCST (Ta) of the first temperature sensitive gel 71. The second LCST (Tb) is made higher than the first LCST by imparting weak hydrophilicity to the first temperature sensitive polymer included in the first temperature sensitive gel 71 to decrease the first LCST (Ta), and imparting strong hydrophilicity to the second temperature sensitive polymer included in the second temperature sensitive gel 72 to increase the second LCST (Tb). The first LCST can be adjusted by adjusting the LCST of the first temperature sensitive gel 71 itself by selecting the first temperature sensitive gel 71, adjusting the ion concentration, adjusting the pH, and the like. The second LCST can also be adjusted by adjusting the LCST of the second temperature sensitive gel 72 itself by selecting the second temperature sensitive gel 72, adjusting the ion concentration, adjusting the pH, and the like.

A volume Va of the first temperature sensitive gel 71, a concentration Da of the first temperature sensitive polymer in the first temperature sensitive gel 71, a volume Vb of the second temperature sensitive gel 72, and a concentration Db of the second temperature sensitive polymer in the second temperature sensitive gel 72 at a temperature lower than the first LCST (Ta) of the first temperature sensitive gel 71 are determined so that the second temperature sensitive gel 72 can absorb the first release polar solvent released by the first temperature sensitive gel 71 in a case where a temperature rise exceeding the first LCST (Ta) occurs. For example, at a temperature lower than the first LCST (Ta), the volume Vb of the second temperature sensitive gel 72 is larger than or equal to the volume Va of the first temperature sensitive gel 71, and the concentration Db of the second temperature sensitive polymer is set to be the same as the concentration Da of the first temperature sensitive polymer.

As illustrated in FIG. 24, in a case where a temperature T1 of a heating element 61 is lower than the first LCST (Ta) of the first temperature sensitive gel 71, the first temperature sensitive gel 71 on an inner side retains without releasing the first polar solvent and has the volume Va. Furthermore, the second temperature sensitive gel 72 on an outer side also retains the second polar solvent without releasing it and has the volume Vb. Therefore, the first polar solvent and the second polar solvent are not present between the first temperature sensitive gel 71 and the second temperature sensitive gel 72 and between the second temperature sensitive gel 72 and the impermeable layer 12.

In a case where the temperature T1 of the heating element 61 is higher than the first LCST (Ta) of the first temperature sensitive gel 71, the first temperature sensitive polymer included in the first temperature sensitive gel 71 changes from hydrophilic to hydrophobic. The change from hydrophilicity to hydrophobicity of the first temperature sensitive polymer occurs before a change from hydrophilicity to hydrophobicity of the second temperature sensitive polymer included in the second temperature sensitive gel 72. The first temperature sensitive gel 71 then releases the first release polar solvent. Furthermore, the second temperature sensitive gel 72 then absorbs the first release polar solvent. Therefore, the first temperature sensitive gel 71 contracts to have a volume Va′ smaller than the volume Va. Furthermore, the second temperature sensitive gel 72 expands to have a volume Vb′ larger than the volume Vb. The first release polar solvent does not accumulate between the first temperature sensitive gel 71 and the second temperature sensitive gel 72.

In a case where the temperature T1 of the heating element 61 becomes higher than the first LCST (Ta) of the first temperature sensitive gel 71 and then the temperature T1 of the heating element 61 becomes higher than the second LCST (Tb) of the second temperature sensitive gel 72, the second temperature sensitive polymer included in the second temperature sensitive gel 72 changes from hydrophilic to hydrophobic. The second temperature sensitive gel 72 then releases the second release polar solvent. Therefore, the second temperature sensitive gel 72 contracts to have a volume Vb″ smaller than the volume Vb′. The second release polar solvent accumulates between the second temperature sensitive gel 72 and the impermeable layer 12 and has a volume w.

In a case where the temperature T1 of the heating element 61 becomes lower than the first LCST (Ta) of the first temperature sensitive gel 71 again, the first temperature sensitive gel 71 swells to have the volume Va again. Furthermore, the second temperature sensitive gel 72 swells to have the volume Vb again. The first temperature sensitive gel 71 and the second temperature sensitive gel 72 then absorb the accumulated second release polar solvent. Therefore, the first release polar solvent and the second release polar solvent do not exist between the first temperature sensitive gel 71 and the second temperature sensitive gel 72 and between the second temperature sensitive gel 72 and the impermeable layer 12.

As a result, the coolant 4 not only absorbs the heat corresponding to the heat capacity of the coolant 4 from the heating element, but also absorbs the heat necessary for the endothermic reaction accompanying the first volume phase transition and the second volume phase transition caused by the first temperature sensitive gel 71 and the second temperature sensitive gel 72, respectively, from the surface of the heating element, and absorbs the heat necessary for the first temperature sensitive gel 71 and the second temperature sensitive gel 72 to release the first release polar solvent and the second release polar solvent, respectively, from the surface of the heating element.

Furthermore, a first release polar solvent 81 and a second release polar solvent 82 respectively released by the first temperature sensitive gel 71 and the second temperature sensitive gel 72 do not permeate the impermeable layer 12. Thus, the first release polar solvent 81 and the second release polar solvent 82 remain inside the coolant 4 and do not leak out of the coolant 4. The remaining first release polar solvent 81 and second release polar solvent 82 are absorbed by the second temperature sensitive gel 72 in a case where a temperature drop exceeding the second LCST occurs, and are absorbed by the first temperature sensitive gel 71 in a case where a temperature drop exceeding the first LCST occurs. As a result, the coolant 4 does not lose the first polar solvent and the second polar solvent included in the first temperature sensitive gel 71 and the second temperature sensitive gel 72, respectively. As a result, the coolant 4 can be repeatedly used.

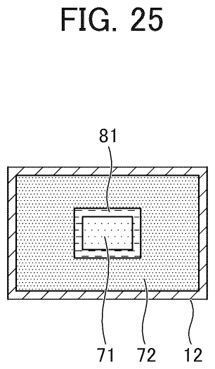

FIG. 25 is a diagram schematically illustrating a state in which the first release polar solvent released by the first temperature sensitive gel is accumulated between the first temperature sensitive gel and the second temperature sensitive gel.

As illustrated in FIG. 25, in a case where the first release polar solvent 81 released by the first temperature sensitive gel 71 is accumulated between the first temperature sensitive gel 71 and the second temperature sensitive gel 72, the first temperature sensitive gel 71 and the second temperature sensitive gel 72 are separated from each other by the accumulated first release polar solvent 81. For this reason, there is a possibility that the cooling effect of the heating element by the coolant 4 is deteriorated.

The temperature sensitive gel included in the coolant 1 of the first embodiment is one temperature sensitive gel 11. Therefore, in the coolant 1 of the first embodiment, in a narrow temperature range near one LCST, the property of the temperature sensitive gel suddenly changes, and sudden heat absorption occurs. Therefore, the heating element can be rapidly cooled.

On the other hand, the temperature sensitive gel included in the coolant 4 of the fourth embodiment is a combination of the plurality of temperature sensitive gels each having the plurality of LCSTs different from each other. Therefore, in the coolant 4 of the fourth embodiment, contents such as a polar solvent are exchanged between the plurality of temperature sensitive gels. Furthermore, in a wide temperature range over the plurality of LCSTs, the property of the temperature sensitive gel gradually changes, and gentle heat absorption occurs. Therefore, the heating element can be gently cooled. Therefore, it is possible to cope with a gradual change in the heating element. This feature becomes more remarkable as the number of LCSTs of the plurality of temperature sensitive gels included in the coolant increases. This is because as the number of the plurality of LCSTs increases, the change in the property of the temperature sensitive gel becomes multistage, and the heat absorption becomes multistage.

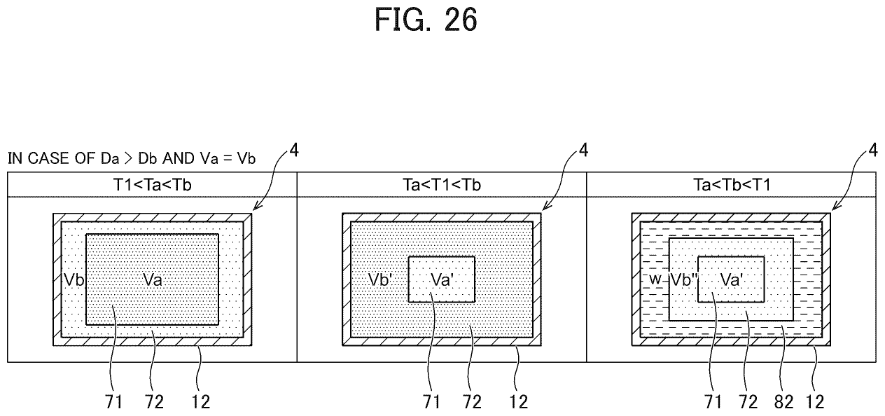

FIG. 26 is a diagram schematically illustrating a temperature change in a state of a coolant according to a first modification of the fourth embodiment.

In the first modification of the fourth embodiment, at a temperature lower than the first LCST (Ta), the volume Vb of the second temperature sensitive gel 72 is made the same as the volume Va of the first temperature sensitive gel 71, and the concentration Db of the second temperature sensitive polymer is made lower than the concentration Da of the first temperature sensitive polymer so that the second temperature sensitive gel 72 can absorb the first release polar solvent released by the first temperature sensitive gel 71 in a case where a temperature rise exceeding the first LCST (Ta) of the first temperature sensitive gel 71 occurs. The reason why the second temperature sensitive gel 72 can absorb the first release polar solvent released by the first temperature sensitive gel 71 by setting the concentration Db of the second temperature sensitive polymer to be lower than the concentration Da of the first temperature sensitive polymer is that a molecular interval in the second temperature sensitive gel 72 becomes wider than a molecular interval in the first temperature sensitive gel 71, and an amount of the polar solvent that can be retained by the second temperature sensitive gel 72 becomes larger than an amount of the polar solvent that can be retained by the first temperature sensitive gel 71.

In the first modification, as illustrated in FIG. 26, in a case where the temperature T1 of the heating element 61 is lower than the first LCST (Ta) of the first temperature sensitive gel 71, the first temperature sensitive gel 71 on an inner side retains the first polar solvent without releasing the first polar solvent, and has the volume Va. Furthermore, the second temperature sensitive gel 72 on an outer side also retains the second polar solvent without releasing it and has the volume Vb. Therefore, the first polar solvent and the second polar solvent are not present between the first temperature sensitive gel 71 and the second temperature sensitive gel 72 and between the second temperature sensitive gel 72 and the impermeable layer 12.

In a case where the temperature T1 of the heating element 61 is higher than the first LCST (Ta) of the first temperature sensitive gel 71, the first temperature sensitive polymer included in the first temperature sensitive gel 71 changes from hydrophilic to hydrophobic. The change from hydrophilicity to hydrophobicity of the first temperature sensitive polymer occurs before a change from hydrophilicity to hydrophobicity of the second temperature sensitive polymer included in the second temperature sensitive gel 72. The first temperature sensitive gel 71 then releases the first release polar solvent. Furthermore, the second temperature sensitive gel 72 then absorbs the first release polar solvent. Therefore, the first temperature sensitive gel 71 contracts to have a volume Va′ smaller than the volume Va. Furthermore, the second temperature sensitive gel 72 expands to have a volume Vb′ larger than the volume Vb. The first release polar solvent does not accumulate between the first temperature sensitive gel 71 and the second temperature sensitive gel 72.

In a case where the temperature T1 of the heating element 61 becomes higher than the first LCST (Ta) of the first temperature sensitive gel 71 and then the temperature T1 of the heating element 61 becomes higher than the second LCST (Tb) of the second temperature sensitive gel 72, the second temperature sensitive polymer included in the second temperature sensitive gel 72 changes from hydrophilic to hydrophobic. The second temperature sensitive gel 72 then releases the second release polar solvent. Therefore, the second temperature sensitive gel 72 contracts to have a volume Vb″ smaller than the volume Vb′. The second release polar solvent accumulates between the second temperature sensitive gel 72 and the impermeable layer 12 and has a volume w.

In a case where the temperature T1 of the heating element 61 becomes lower than the first LCST (Ta) of the first temperature sensitive gel 71 again, the first temperature sensitive gel 71 swells to have the volume Va again. Furthermore, the second temperature sensitive gel 72 swells to have the volume Vb again. The first temperature sensitive gel 71 and the second temperature sensitive gel 72 then absorb the accumulated second release polar solvent. Therefore, the first release polar solvent and the second release polar solvent do not exist between the first temperature sensitive gel 71 and the second temperature sensitive gel 72 and between the second temperature sensitive gel 72 and the impermeable layer 12.

As a result, the coolant 4 not only absorbs the heat corresponding to the heat capacity of the coolant 4 from the heating element, but also absorbs the heat necessary for the endothermic reaction accompanying the first volume phase transition and the second volume phase transition caused by the first temperature sensitive gel 71 and the second temperature sensitive gel 72, respectively, from the surface of the heating element, and absorbs the heat necessary for the first temperature sensitive gel 71 and the second temperature sensitive gel 72 to release the first release polar solvent and the second release polar solvent 82, respectively, from the surface of the heating element.

Furthermore, the second release polar solvent 82 released by the second temperature sensitive gel 72 does not permeate the impermeable layer 12. Therefore, the first release polar solvent and the second release polar solvent 82 remain inside the coolant 4 and do not leak out of the coolant 4. The remaining first release polar solvent and second release polar solvent 82 are absorbed by the second temperature sensitive gel 72 in a case where a temperature drop exceeding the second LCST occurs, and are absorbed by the first temperature sensitive gel 71 in a case where a temperature drop exceeding the first LCST occurs. As a result, the coolant 4 does not lose the first polar solvent and the second polar solvent included in the first temperature sensitive gel 71 and the second temperature sensitive gel 72, respectively. As a result, the coolant 4 can be repeatedly used.

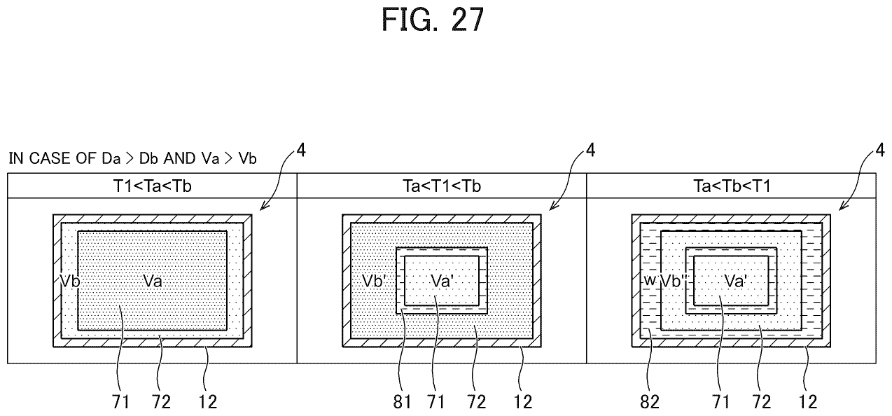

FIG. 27 is a diagram schematically illustrating a temperature change in a state of a coolant of a reference example.

In the reference example, at a temperature lower than the first LCST (Ta) of the first temperature sensitive gel 71, the volume Vb of the second temperature sensitive gel 72 is made smaller than the volume Va of the first temperature sensitive gel 71, and the concentration Db of the second temperature sensitive polymer is made lower than the concentration Da of the first temperature sensitive polymer.

In the reference example, as illustrated in FIG. 27, in a case where the temperature T1 of the heating element 61 is lower than the first LCST (Ta) of the first temperature sensitive gel 71, the first temperature sensitive gel 71 on an inner side retains the first polar solvent without releasing the solvent, and has the volume Va. Furthermore, the second temperature sensitive gel 72 on an outer side also retains the second polar solvent without releasing it and has the volume Vb. Therefore, the first polar solvent and the second polar solvent are not present between the first temperature sensitive gel 71 and the second temperature sensitive gel 72 and between the second temperature sensitive gel 72 and the impermeable layer 12.

In a case where the temperature T1 of the heating element 61 is higher than the first LCST (Ta), the first temperature sensitive polymer included in the first temperature sensitive gel 71 changes from hydrophilic to hydrophobic. The first temperature sensitive gel 71 then releases the first release polar solvent. Furthermore, the second temperature sensitive gel 72 then absorbs a part of the first release polar solvent. Therefore, the first temperature sensitive gel 71 contracts to have a volume Va′ smaller than the volume Va. Furthermore, the second temperature sensitive gel 72 expands to have a volume Vb′ larger than the volume Vb. However, the second temperature sensitive gel 72 cannot absorb all of the first release polar solvent 81. Thus, a part of the first release polar solvent 81 accumulates between the first temperature sensitive gel 71 and the second temperature sensitive gel 72.

In a case where the temperature T1 of the heating element 61 becomes higher than the first LCST (Ta) and then the temperature T1 of the heating element 61 becomes higher than the second LCST (Tb), the second temperature sensitive polymer included in the second temperature sensitive gel 72 changes from hydrophilic to hydrophobic. The second temperature sensitive gel 72 then releases the second release polar solvent. Therefore, the second temperature sensitive gel 72 contracts to have a volume Vb″ smaller than the volume Vb′. The second release polar solvent accumulates between the second temperature sensitive gel 72 and the impermeable layer 12 and has a volume w. At this time, the first release polar solvent 81 remains accumulated between the first temperature sensitive gel 71 and the second temperature sensitive gel 72. The accumulated first release polar solvent 81 may inhibit heat transfer and reduce the ability of the coolant 4 to cool the heating element.

Next, an example of a method of manufacturing the coolant 4 will be described.

When the coolant 4 is produced, a first solution containing the pre-crosslinking precursor of the first temperature sensitive polymer and the first polar solvent is prepared.

Subsequently, the prepared first solution is subjected to a gelation treatment such as a treatment for crosslinking the pre-crosslinking precursor. As a result, the first temperature sensitive gel 71 containing the first temperature sensitive polymer and the first polar solvent is produced.

Subsequently, a second solution containing the pre-crosslinking precursor of the second temperature sensitive polymer and the second polar solvent is prepared.

Subsequently, the prepared second solution is applied to a surface of the prepared first temperature sensitive gel 71.

Subsequently, a gelation treatment such as a treatment for crosslinking the pre-crosslinking precursor is performed on the applied second solution. As a result, the second temperature sensitive gel 72 containing the second temperature sensitive polymer and the second polar solvent is produced.

A polymer solution containing a pre-crosslinking precursor of another temperature sensitive polymer and another polar solvent is applied to a surface of a temperature sensitive gel containing one temperature sensitive polymer and one polar solvent, and the applied polymer solution is subjected to a gelation treatment to produce a temperature sensitive gel containing another temperature sensitive polymer and another polar solvent. By repeating the process, a coolant having a multilayer structure including three or more layers can also be produced. In a case where the process is repeated, a volume, a thickness, and the like of the temperature sensitive gel can be adjusted by changing the number of times of repeating the process.

Instead of applying the solution to the surface of the temperature sensitive gel, the temperature sensitive gel may be immersed in the solution. In a case where the temperature sensitive gel is immersed in the solution, the volume, thickness, and the like of the temperature sensitive gel can also be adjusted by changing the time during which the temperature sensitive gel is immersed in the solution.

The coolant 4 may include three or more types of temperature sensitive gels. In this case, desirably, a volume of the temperature sensitive gel on an outer side is larger than a volume of the temperature sensitive gel on an inner side. In a case where the volume of the outer temperature sensitive gel is the same as or smaller than the volume of the inner temperature sensitive gel, desirably the concentration of the outer temperature sensitive gel is lower than the concentration of the inner temperature sensitive gel, and the amount of polar solvent that the outer temperature sensitive gel can contain is greater than the amount of polar solvent that the inner temperature sensitive gel can contain.

### 5 Fifth Embodiment

Hereinafter, differences between a fifth embodiment and the first embodiment will be described. Regarding points that are not described, a configuration similar to the configuration adopted in the first embodiment is also adopted in the fifth embodiment.

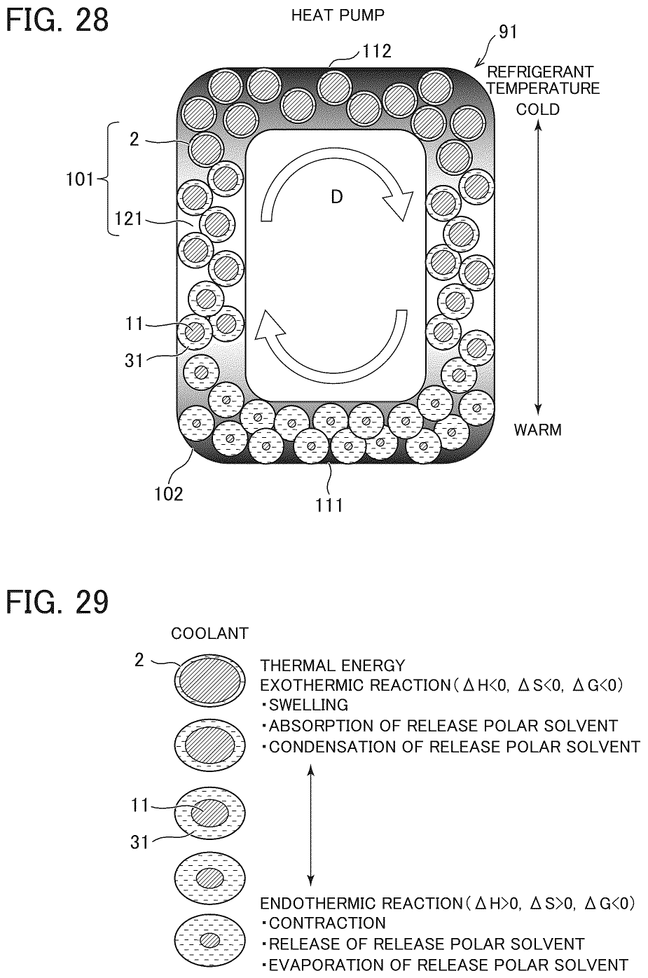

FIG. 28 is a cross-sectional view schematically illustrating a heat pump including a heat pump refrigerant according to the fifth embodiment.

A heat pump 91 illustrated in FIG. 28 circulates a heat pump refrigerant 101 of the fifth embodiment in a circulation direction D along a circulation path 102. A temperature of the circulated heat pump refrigerant 101 increases in a first section 111 of the circulation path 102 and decreases in a second section 112 of the circulation path 102.

As illustrated in FIG. 28, the heat pump refrigerant 101 includes the coolant 2 according to the second embodiment and a liquid refrigerant 121. The heat pump refrigerant 101 may include the coolant 4 of the fourth embodiment instead of the coolant 2 of the second embodiment.

The coolant 2 has a particulate shape. The coolant 2 is mixed into the liquid refrigerant 121. The coolant 2 is dispersed in the liquid refrigerant 121, and is circulated in the circulation direction D along the circulation path 102 together with the liquid refrigerant 121. Therefore, a temperature of the coolant 2 increases in the first section 111 of the circulation path 102 and decreases in the second section 112 of the circulation path 102.

FIG. 29 is a diagram schematically illustrating a temperature change in a state of the coolant included in the heat pump refrigerant according to the fifth embodiment.

As illustrated in FIG. 29, in a case where the coolant 2 is conveyed to the first section 111 and has a high temperature, the coolant 2 undergoes a volume phase transition accompanied by an endothermic reaction. At that time, the polar solvent 22 contained in the temperature sensitive gel 11 easily moves. Therefore, the temperature sensitive gel 11 contracts by releasing the release polar solvent 31. The release polar solvent 31 remains inside the impermeable layer 12. All or a part of the release polar solvent 31 evaporates. A change ΔH in enthalpy H at this time is positive (ΔH>0). Furthermore, a change ΔS in entropy S at this time is positive (ΔS>0). Furthermore, in a case where a temperature is T, a change ΔG=ΔH−TΔS in the free energy G of the Gibbs at this time of a system constituted by the temperature sensitive gel 11 and the release polar solvent 31 is negative (ΔG<0) under the condition that an environmental temperature in the refrigerant to which the system is exposed is sufficiently high.

On the other hand, in a case where the coolant 2 is conveyed to the second section 112 and has a low temperature, the coolant undergoes a volume phase transition accompanied by an exothermic reaction. At that time, all or a part of the evaporated release polar solvent 31 is condensed. Furthermore, the temperature sensitive gel 11 swells by absorbing the remaining release polar solvent 31. A change ΔH in enthalpy H at this time is negative (ΔH<0). Furthermore, a change ΔS in entropy S at this time is negative (ΔS<0). Furthermore, a change ΔG=ΔH−TΔS in the free energy G of the Gibbs at this time of the system constituted by the temperature sensitive gel 11 and the release polar solvent 31 is negative (ΔG<0) under the condition that an environmental temperature in the refrigerant to which the system is exposed is sufficiently low.

Therefore, in a case where the coolant 2 is conveyed to the first section 111 and has a high temperature, the coolant causes a volume phase transition accompanied by an endothermic reaction to absorb reaction heat, increases entropy S to absorb the heat, and evaporates all or a part of the release polar solvent 31 to absorb latent heat.

On the other hand, in a case where the coolant 2 is conveyed to the second section 112 and has a low temperature, the coolant causes a volume phase transition accompanied by an exothermic reaction to release reaction heat, reduces entropy S to release the heat, and condenses the evaporated release polar solvent 31 to release latent heat.

As a result, the heat pump refrigerant 101 including the coolant 2 and the liquid refrigerant 121 has an ability to carry heat higher than an ability to carry heat of a heat pump refrigerant including only the liquid refrigerant 121. Accordingly, the amount of heat pump refrigerant 101 used can be reduced.

The present disclosure is not limited to the above embodiments, and may be replaced with a configuration substantially identical to the configuration described in the above embodiments, a configuration having the same function and effect, or a configuration capable of achieving the same object.

### DESCRIPTION OF REFERENCE SIGNS

1, 2, 3, 4 coolant
11 temperature sensitive gel
12 impermeable layer
21 temperature sensitive polymer
22 polar solvent
31 release polar solvent
41 circuit board
41a first principal surface
41b second principal surface
42 capacitor
42a outer peripheral surface
42b top surface
43 cylindrical heating element
43s in-cylinder space
51 first portion
52 second portion
61 heating element
71 first temperature sensitive gel
72 second temperature sensitive gel
81 first release polar solvent
82 second release polar solvent
91 heat pump
101 heat pump refrigerant
102 circulation path
111 first section
112 second section
121 liquid refrigerant
D circulation direction

What is claimed is:

1. A coolant comprising a temperature sensitive gel including a temperature sensitive polymer having hydrophilicity at a temperature lower than a lower critical solution temperature and hydrophobicity at a temperature higher than the lower critical solution temperature, and a polar solvent that wets the temperature sensitive polymer, the temperature sensitive gel undergoing a volume phase transition accompanied by an endothermic reaction in a case where a temperature rise exceeding the lower critical solution temperature occurs.

2. The coolant according to claim 1, wherein the temperature sensitive gel contracts to release a part of the polar solvent in a case where the temperature rise occurs.

3. The coolant according to claim 1, further comprising an impermeable layer that covers the temperature sensitive gel and does not allow the polar solvent to permeate through the impermeable layer.

4. The coolant according to claim 3, wherein the impermeable layer contains at least one selected from the group consisting of polyvinylidene chloride, silicone gel, polyethylene, and polyurethane.

5. The coolant according to claim 1, wherein
the lower critical solution temperature is a first lower critical solution temperature,
the temperature sensitive polymer is a first temperature sensitive polymer,
the polar solvent is a first polar solvent,
the volume phase transition is a first volume phase transition, and
the temperature sensitive gel is a first temperature sensitive gel,
the coolant further comprising
a second temperature sensitive gel including a second temperature sensitive polymer having hydrophilicity at a temperature lower than a second lower critical solution temperature different from the first lower critical solution temperature and having hydrophobicity at a temperature higher than the second lower critical solution temperature, and a second polar solvent that wets the second temperature sensitive polymer, the second temperature sensitive gel being in contact with the first temperature sensitive gel and undergoing a second volume phase transition in a case where a temperature change exceeding the second lower critical solution temperature occurs.

6. The coolant according to claim 5, wherein
the coolant has a thread-like shape,
the first temperature sensitive gel is a core,
the second temperature sensitive gel is a sheath covering the core, and
the second lower critical solution temperature is lower than the first lower critical solution temperature.

7. The coolant according to claim 6, further comprising an impermeable layer that covers the sheath and does not allow the first polar solvent and the second polar solvent to permeate through the impermeable layer.

8. The coolant according to claim 7, wherein the impermeable layer contains at least one selected from the group consisting of polyvinylidene chloride, silicone gel, polyethylene, and polyurethane.

9. The coolant according to claim 5, wherein the second lower critical solution temperature is higher than the first lower critical solution temperature.

10. The coolant according to claim 9, wherein the second temperature sensitive gel envelops the first temperature sensitive gel.

11. The coolant according to claim 9, wherein a volume of the second temperature sensitive gel is larger than a volume of the first temperature sensitive gel at a temperature lower than the first lower critical solution temperature.

12. The coolant according to claim 9, wherein a concentration of the second temperature sensitive polymer in the second temperature sensitive gel is lower than a concentration of the first temperature sensitive polymer in the first temperature sensitive gel at a temperature lower than the first lower critical solution temperature.

13. The coolant according to claim 1, wherein
the temperature sensitive polymer contains at least one selected from the group consisting of:
(1) at least one polymer selected from the group consisting of a cellulose derivative, polyvinyl ether, a derivative of polyvinyl ether, poly (N-alkyl (meth) acrylamide), a derivative of poly (N-alkyl (meth) acrylamide), poly (N-vinylalkylamide), a derivative of poly (N-vinylalkylamide), poly (N-vinylpyrrolidone), a derivative of poly (N-vinylpyrrolidone), poly (2-alkyl-2-oxazoline), a derivative of poly (2-alkyl-2-oxazoline), polyvinyl alkyl ether, a derivative of polyvinyl alkyl ether, a copolymer of polyethylene oxide and polypropylene oxide, a derivative of a copolymer of polyethylene oxide and polypropylene oxide, poly (oxyethylene vinyl ether), and a derivative of poly (oxyethylene vinyl ether);
(2) a copolymer of at least two polymers selected from the group; and
(3) a crosslinked body of at least one polymer selected from the group consisting of the at least one polymer and the copolymer of the at least two polymers.

14. The coolant according to claim 1, wherein
the temperature sensitive gel contains at least one selected from the group consisting of:
(1) at least one polymer selected from the group consisting of polyethylene glycol, 2-methacryloyloxyethyl phosphorylcholine, poly (meth) acrylic acid, poly (meth) acrylate, alginic acid, alginate, hyaluronic acid, hyaluronic acid salt, chitosan, and a cellulose derivative;
(2) a copolymer of at least two polymers selected from the group; and
(3) a crosslinked body of at least one polymer selected from the group consisting of the at least one polymer and the copolymer of the at least two polymers.

15. The coolant according to claim 1, wherein the polar solvent contains at least one selected from the group consisting of water and an ionic liquid.

16. The coolant according to claim 1, wherein the coolant has a flat plate shape, a thread-like shape, a mesh shape, a spherical shape, a conical shape, a rod shape, a string-like shape, a coil shape, a folding screen shape, a granular shape, or a pulverized shape, or a plate-like or cloth-like outer shape in which a plurality of holes are formed.

17. A heat pump refrigerant comprising:
the coolant according to claim 3; and
a liquid refrigerant mixed with the coolant.
